(19) United States
(12) Patent Application Publication
(10) Pub. No.: US 2013/0038586 A1
(43) Pub. Date: Feb. 14, 2013

(54) LIQUID CRYSTAL DISPLAY DEVICE AND METHOD FOR IMPROVING DISPLAY QUALITY OF THE SAME

(71) Applicants: CHUNG-CHIH HSIAO, Yangmei Town (TW); Chun-cheng Hou, Chiayi City (TW)

(72) Inventors: CHUNG-CHIH HSIAO, Yangmei Town (TW); Chun-cheng Hou, Chiayi City (TW)

(73) Assignee: Chunghwa Picture Tubes, LTD., Bade City (TW)

(21) Appl. No.: 13/300,532

(22) Filed: Nov. 18, 2011

(30) Foreign Application Priority Data
Aug. 12, 2011 (TW) 100128901

(51) Int. Cl. G09G 5/00; G09G 3/36

(52) U.S. Cl. 345/208; 345/87

(57) ABSTRACT

A liquid crystal display device including a liquid crystal panel, a gate driver unit, a source driver unit and a clock generator and a method thereof are disclosed to improve display quality. The liquid crystal panel comprises a pixel array for displaying images. The gate driver unit for generating plural driving signals drives the pixel array. The source driver unit for generating plural driving signals drives the data of the image signals. The clock generator electrically coupled to the gate driver unit generates clock signals to control an operation of the gate driver unit. A bright line is likely to occur in an image area since the last two gate driver output lines of the last two stages are not coupled to the liquid crystal panel. A solution with the duty cycle of a clock signal generated by the clock generator is adjusted to solve the aforementioned problem.

### BACKGROUND OF THE INVENTION

1. Field of the Invention

The present invention relates to a liquid crystal display device and its method for improving display quality and more particularly to a liquid crystal display device and its method that feature an improvement of the last bright line by means of adjustment of the duty cycle of its clock signal.

2. Description of the Prior Art

As shown in FIG. 1, a traditional liquid crystal display device 1 of GIP (gate in panel)-type structure is obtained by fabricating gate driver integrated circuits (gate driver ICs) 25 directly on a liquid crystal panel 10 of the GIP, which enables to cut down cost and to simplify manufacturing process. The liquid crystal display device 1 comprises: a liquid crystal panel 13, a gate driver unit 28, a source driver unit 40 and a clock generator 30. The liquid crystal panel 13 comprises a pixel array 45, where each pixel is controlled by a gate line 15 and a source line 18 coupled to itself to display its image. The pixel array 45 comprises n pieces of gate lines G1-Gn, m pieces of source lines D1-Dm and n×m pieces of pixels. The demanded driving signals of the gate lines 15 are provided by n pieces of external gate driver ICs 25.

The gate driver unit 28 of GIP-type structure comprises plural shift registers that are electrically coupled in series. As shown in FIG. 2A, the FIG. 2A is a schematic diagram of the link of traditional shift registers, where the outputs of Left 769 stage and Right 769 stage shift registers respectively are used to reset corresponding Left 768 stage and Right 768 stage shift registers. Since the outputs of the Left 769 stage and the Right 769 stage shift registers are not connected to any pixel of the panel, the last two gate lines of the gate driver unit 28 connected to a pixel are GO768 63 and GE768 62 of the Left 768 stage and the Right 768 stage shift registers respectively. As shown in FIG. 2B, FIG. 2B shows the action of the plural shift registers with respect to the last gate line GE768 62. The clock signal in FIG. 2C and the equivalent circuit of the Right stage shift register in FIG. 2D illustrate the action of the foregoing Right 768 stage shift register and the last gate line GE768 62. One thing to be noticed here is that the working principle for the second last gate line is exactly the same as that of the last gate line. And that will not be repeated here. FIG. 2C shows an output waveform CLK of the clock generator 30. The output waveform CLK is a pulse wave, where its high voltage level and low voltage level are a first voltage VGH 82 and a second voltage VEEG 84 respectively. As shown in FIGS. 2B and 2D, FIG. 2D is an equivalent circuit diagram of the Right 768 stage shift register. AS clock waveforms CLK2 & CLK4 shown in FIG. 2E are inputted, the rising edge and the falling edge of CLK2 and CLK4 respectively are aligned in opposite heading to each other, and at the moment at 86, Q point 65 shown in 2B is set to a high voltage level VGH through GE767 66, which turns on the transistor T3 and makes CLK4 61 to be a low voltage level VEEG, and a capacitor C is charged to 30V. Once the GE767 66 is in a low voltage level VEEG, and it will be turned off and the Q point is floating. Until the CLK4 61 goes high VGH, the Q point changes to 54V, and GE768 62 is in a high voltage level VGH and is equivalent to CLK4 61. Referring again to FIGS. 2B & 2D, once the GE768 62 is in a high voltage level, which will set the Right 769 shift register till Q point of the Right 769 shift register changes to 54V, and GE769 70 goes high VGH. As shown in FIG. 2D, once the GE769 70 is in a high voltage level VGH, the transistor T4 of the Right 768 shift register is turned on, which tears the Q point down to VGL, turns the T3 off and enables the GE768 to discharge toward low voltage. The T3 acts as an equivalent capacitor if viewing from the GE768, and the GE768 would discharge as shown in FIG. 3A. At this moment, once the source line presents a 0V, the GE768 will stay in a positive voltage (approximately 9V), which enables the pixels of the liquid crystal panel to be written with a 0V voltage provided that the source is 0V. Therefore, the GE768 of the Right 768 stage shift register will cause a comparatively bright light at the pixels coupled to the last gate line. By the same principle, the GO768 of the Left 768 stage shift register will also cause a comparatively bright light at the pixels coupled to the second last gate line. This outcome will give rise to the phenomenon shown in FIG. 3B, which is a bright line 60 produced by the pixels that are coupled to the last two gate lines, and it means pixels in low voltage will give rise to a bright line.

### SUMMARY OF THE INVENTION

The objective of the present invention is to provide a liquid crystal display device and its method, which is capable of alleviating or even eliminating the bright line to accomplish the goal of improving the quality of the liquid crystal display device.

To achieve the aforementioned objective, a liquid crystal display device of GIP (gate in panel)-type structure is provided according to a distinguishing feature of the present invention, where the device comprises a liquid crystal panel, which comprises a pixel array, for the display of image; a gate driver unit, having plural gate lines to couple to the pixel array, for the generation of plural driving signals to drive the pixel array; a source driver unit, for the generation of plural driving signals to drive the data of image signals; and a clock generator, electrically coupling to the gate driver unit, for the generation of plural clock signals, to control the action of the gate driver unit.

According to the liquid crystal display device of the present invention, the gate driver unit further comprises plural shift registers that are electrically coupled in series, where each shift register corresponds to one row of the pixel array, to control input clock of the shift register where its two gate lines couple to the last row of the pixel array, to have the triggering edge of its input clock not in alignment with the input clock of the next stage shift register, for the purpose of matching up with the turn-off action of the last two gate lines, to eliminate the bright line. The way to control the input clock of the shift registers where their two gate lines couple to the last row of the pixel array is through the adjustment of the duty cycle of the input clock.

According to the liquid crystal display device of the present invention, the control of the input clock of the shift registers where their two gate lines couple to the last row of the pixel array is by way of adjusting the duty cycle of the clock, where the rising edge is delayed and the falling edge is advanced by time.

According to the liquid crystal display device of the present invention, the outputs of the clock generator are plural pulse signals, where the high voltage level and the low voltage level of the signals are a first voltage and a second voltage respectively.

According to the liquid crystal display device of the present invention, the plural shift registers that correspond to the last gate line comprise:

a first shift register and a second shift register which is a next stage shift register, where the output of the second shift register couples to the first shift register, and the output of the first shift register is the output of the last gate line, and further couples to the second shift register. The first shift register is provided with a first input end, which is coupled to one of the plural clock signals generated by the clock generator; and a second input end, coupling to a gate line output of a front stage shift register; and a first output end, which is a gate line output of the first shift register, and the second shift register is provided with a third input end, coupling to one of the plural clock signals generated by the clock generator and coupling to a starting signal.

According to the liquid crystal display device of the present invention, the adjustment of the duty cycle of one of the plural clock signals is accomplished either by hardware circuits or software in a single chip in the clock generator.

According to the driving method of the liquid crystal display device of the present invention, the liquid crystal display device comprises a liquid crystal panel, a gate driver unit, a source driver unit and a clock generator, where the plural shift registers correspond to the last gate line comprise:

a first shift register and a second shift register which is a next stage shift register, where the output of the second shift register couples to the first shift register, and the output of the first shift register is the output of the last gate line, and further couples to the second shift register. The first shift register is provided with a first input end, which is coupled to one of the plural clock signals generated by the clock generator; and a second input end, coupling to a gate line output of a front stage shift register; and a first output end, which is a gate line output of the first shift register, and the second shift register is provided with a third input end, coupling to one of the plural clock signals generated by the clock generator and coupling to a starting signal. The first input end and the third input end are inputted a rising edge and a falling edge clock signals respectively which are aligned in opposite heading to each other, the driving method comprises: adjusting the duty cycle of one of the plural clock signals of the first input end, to have the rising edge and the falling edge of its trigger edges not in alignment with the rising edge and the falling edge of the trigger edges of the input clock of the next stage shift register inputted by the third input end;
transmitting the starting signal, adjusted clock signal of the first input end, one of the plural clock signals of the third input end of the next stage shift register and a gate line of front stage shift register to the second input end outputs to the plural shift registers correspond to the last gate line;
transmitting the driving signals to the last row of the pixel array; and
driving the last row of the pixel array by the driving signals.

According to the driving method of the liquid crystal display device of the present invention, the gate driver unit comprises plural shift registers which are electrically coupled in series, where each shift register corresponds to one row of the pixel array. According to the driving method of the liquid crystal display device of the present invention, the outputs of the clock generator are plural pulse clock signals, where the high voltage level and low voltage level of the clock signals are a first voltage and a second voltage respectively.

According to the driving method of the liquid crystal display device of the present invention, the signal of the first input end is coupled to one of plural outputted clock signals of the clock generator, where its rising edge is delayed and its falling edge is advanced by time, which accomplishes the improvement of the display quality of the liquid crystal display device.

### BRIEF DESCRIPTION OF THE DRAWINGS

FIG. 1 is a schematic diagram of a traditional liquid crystal display device of GIP-type structure;

FIG. 2A is a schematic diagram of plural shift registers of the traditional liquid crystal display device electrically coupled in series;

FIG. 2B is a schematic diagram of the last stage output GE768 of the Right 768 stage shift register;

FIG. 2C is a schematic diagram of the voltage levels of a clock signal CLK;

FIG. 2D is an equivalent circuit diagram of the last stage output GE768 of the Right 768 stage shift register;

FIG. 2E is a diagram showing the relation of the alignment of the triggering edges of traditional clock pulses CLK2 & CLK4;

FIG. 3A is a diagram showing the traditional operation of the last stage output GE768 and the image data with respect to source driver unit;

FIG. 3B is a diagram showing the bright line generated by the liquid crystal display device;

FIG. 4A is a diagram showing the relation of misalignment between the trigger edges of the adjusted clock pulses CLK4 & CLK2; and

FIG. 4B is a diagram showing the operation of the last stage output GE768 and the image data with respect to source driver unit after adjustment.

### DETAILED DESCRIPTION OF THE INVENTION

The techniques of the present invention are detailed described with reference to the following accompanying drawings.

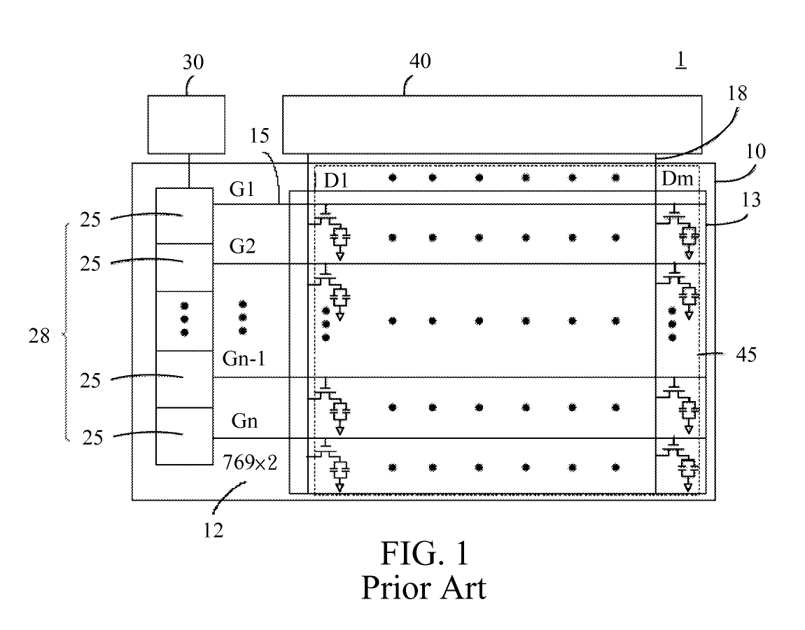

There is a technical equivalence between the hardware portion of the present invention and that of the prior art. Referring to FIG. 1, FIG. 1 is a schematic diagram of a traditional liquid crystal display device 1, and the present invention is also referenced by FIG. 1. The liquid crystal display device 1 adopts GIP-type structure, comprising a liquid crystal panel 13, which comprises a pixel array 45, for the display of image; a gate driver unit 28, having 769×2 gate lines 12 to couple to the pixel array 45, for the generation of 769×2 driving signals to drive the pixel array 45; a clock generator 30, electrically coupling to the gate driver unit 28, for the generation of 4 sets of clock signals CLK1-CLK4 (not shown in the drawings), to control the action of the gate driver unit 28; and a source driver unit 40, for the generation of plural driving signals to drive the data of image signals. Since GIP-type structure is selected, the gate driver unit 28 is fabricated on the liquid crystal display panel 13. Thus, the cost can be substantially cut down and the process can be simplified.

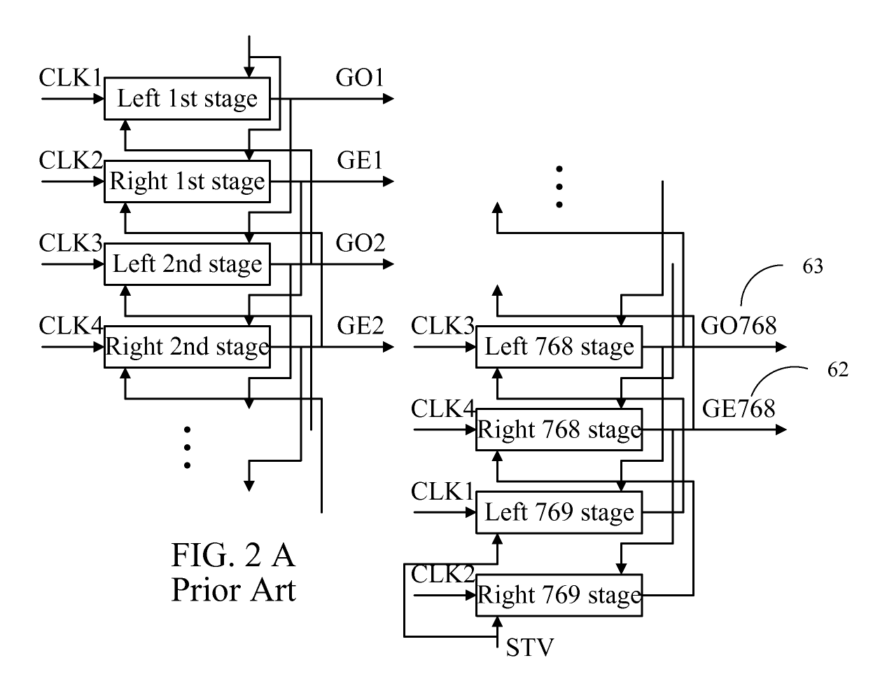

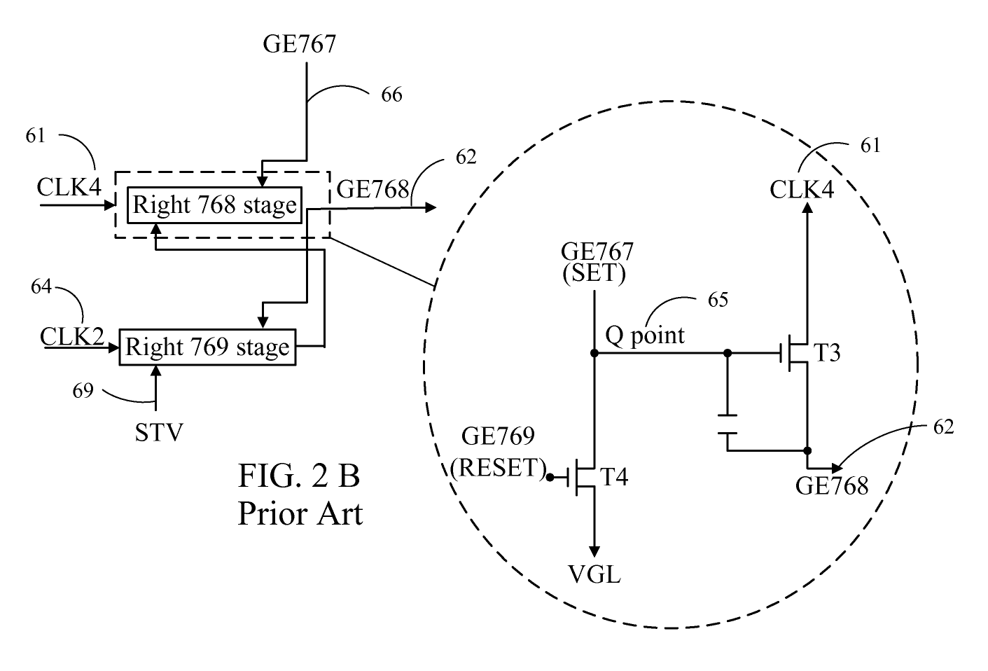

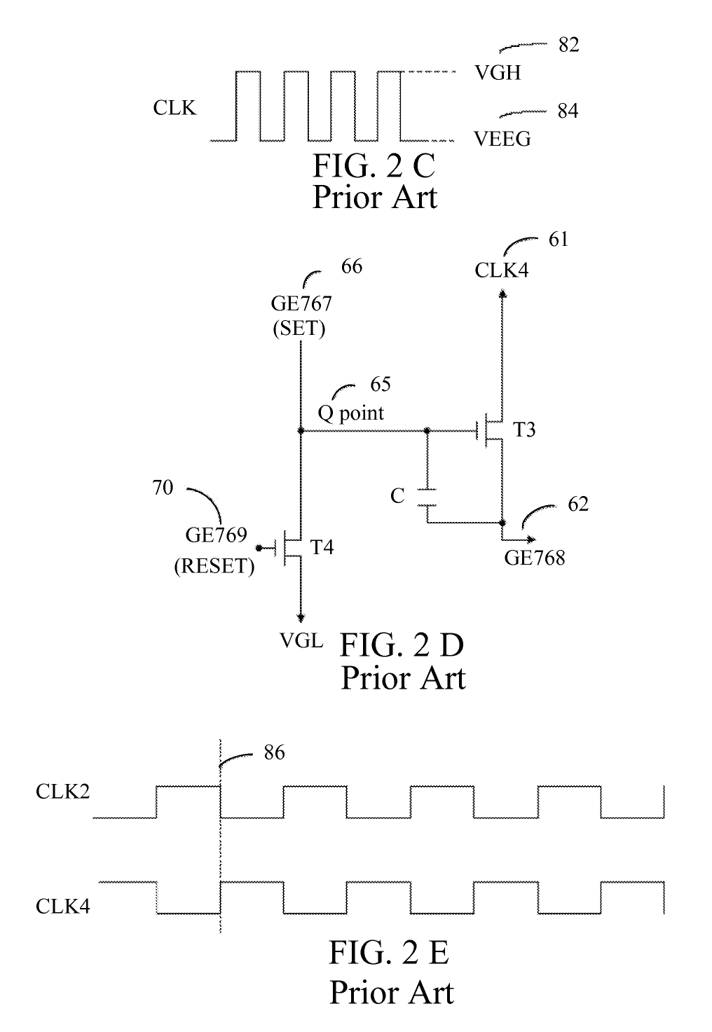

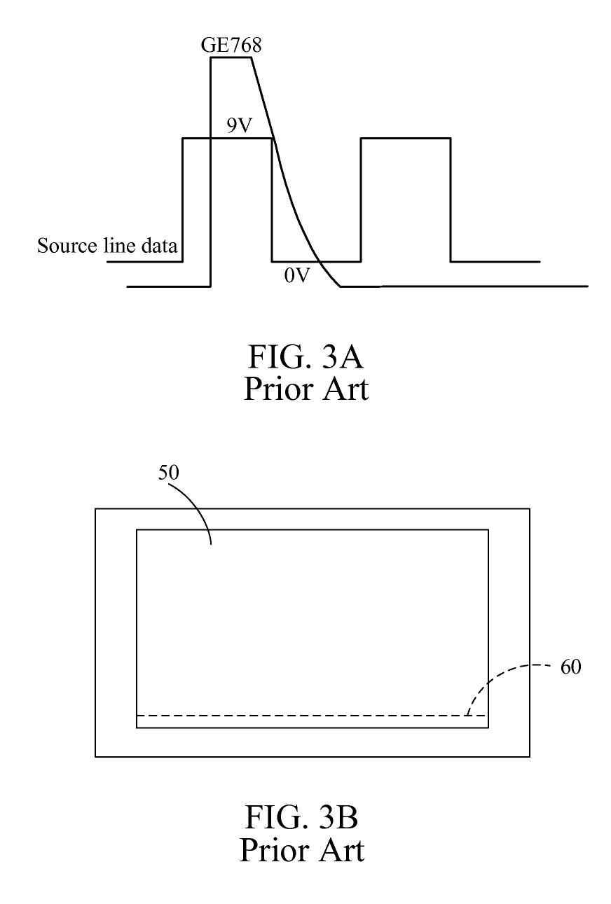

The gate driver unit 28 comprises plural shift registers which are electrically coupled in series (not shown in the drawing), where each shift register corresponds to one row of the pixel array 45. Referring to FIG. 2A, FIG. 2A is a schematic diagram of plural shift registers electrically coupled in series of the present invention, where the shift registers are categorized into Left and Right stages, and a shift register with a serial number will have the same serial number for its gate output line. (For instance, the gate line outputs of Left 768 and Right 768 stage shift registers are GO768 63 and GE768 62 respectively, which enables the pixels at the last row of the liquid crystal panel 13 to yield image.) The shift registers start to couple in series from Left 1 and Right 1 stages to Left 769 and Right 769 stages, and the clock signals CLK1-CLK4 are assigned/inputted to the above shift registers in a cyclical order. A particular concentration here is that clock signals CLK2 and CLK4 are opposite in phase and the rising edge of the CLK2 is aligned to the falling edge of the CLK4, and vice versa. Each shift register corresponds to a gate line output, and the gate line outputs include from GO1, GE1 up to GO768, GE768. The last two gate line outputs GO769, GE769 are not connected to the pixel array 45, but they are connected to the Left 768 and Right 768 stage shift registers instead, to reset the last two gate line outputs GO768 63, GE768 62. The operation of hardware portion of the present invention is equivalent to the prior technique, which is shown in the foregoing drawings, and is not described more details hereinafter.

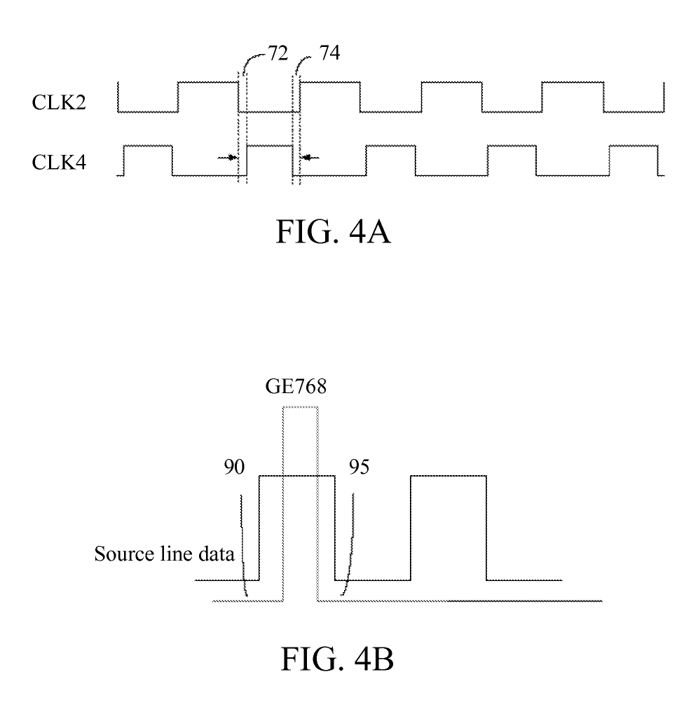

Referring again to FIGS. 2B and 2D with the support by FIG. 4A, before the clock input CLK2 64 of the Right 769 stage shift register goes high VGH, the transistor T4 of the Right 768 stage shift register is turned off, and the clock input CLK4 61 of the Right 768 stage shift register is still kept in low voltage level VEEG (−6V). As shown in FIG. 4A, since a delay in the rising edge and an advance in the falling edge give rise to a trigger difference at 72, 74, which makes the transistor T3 of the Right 768 stage shift register to stay turning on (for Q is 54V). And the GE768 is directly the CLK4, that is, VEEG (−6V), not same as the prior art instead, where the GE768 62 is in high voltage level VGH (24V), which as a result is affected by the equivalent capacitor effect to discharge slowly, to have a phenomenon of remaining positive voltage (approximately 9V) that turns on the GE768 62 of the Right 768 stage shift register to cause a brighter light. As in the foregoing description, referring to FIG. 4B, once the source line is in 0V at 90, 95, the GE768 is in VEEG (−6V), and at the moment, the pixels of the liquid crystal display panel will not assert a 0V voltage. Therefore, the GE768 of the Right 768 stage shift register won't produce a brighter light. Accordingly, by adjusting the duty cycle of the clock signal CLK4 of the Right 768 stage shift register, to improve the bright line of the last row of pixels, and this will be described in detail hereinafter. To achieve the adjustment of the duty cycle of the CLK4 of the Right 768 stage shift register, a RC circuit is applied to change the trigger edge of the CLK4 of the Right 768 stage shift register, or a modification of the software program in the EEPROM of the clock generator also can be applied to adjust the duty cycle of the CLK4 of the Right 768 stage shift register. Similarly, the adjustment of the duty cycle of the CLK3 of the Left 768 stage shift register can improve the bright line of the last row of pixels corresponding to the second last gate line.

Referring to FIG. 4A, the improvement method of the liquid crystal display device of the present invention is through the adjustment of the duty cycle of the CLK4 of the Right 768 stage shift register, that is, the adjustment of the pulse duration, to let its trigger edge (rising edge or falling edge) to differentiate from that of the CLK2 of the Right 769 stage shift register by a difference 72, 74, which is a delay in the rising edge and an advance in the falling edge of the CLK4, where this target can be accomplished by placing a RC circuits to change the pulse duration of the CLK4 of the Right 768 stage shift register, or by modifying the software program in the EEPROM of the clock generator. With the same approach as the aforesaid, the pulse duration of the CLK3 of the Left 768 stage shift register is adjusted such that its trigger edge is not in alignment with the trigger edge of the clock CLK1, to improve the bright line of the last row of pixels corresponding to the last two gate lines.

Referring to FIG. 1, FIG. 1 shows a driving method of the traditional liquid crystal display device, and the present invention is referenced by FIG. 1, where the liquid crystal display device of the GIP-type structure comprises a liquid crystal panel 10, a gate driver unit 28, a source driver unit 40 and a clock generator 30, and the liquid crystal panel 10 comprises a pixel array 45. As in FIG. 2B, the plural shift registers that correspond to the last gate line comprise:

the Right 768 stage shift register and the Right 769 stage shift register, where the output of the Right 769 stage shift register couples to the Right 768 stage shift register, and the output of the Right 768 stage shift register, except the output of the last gate line GE768, couples to the Right 769 stage shift register. The Right 768 stage shift register is provided with a first input end CLK4 61, which is coupled to the fourth clock generated by the clock generator 30; and a second input end, coupled to a gate line output GE767 66 of a front stage shift register; and a first output end, which is a gate line output GE768 62 of the first shift register, and the Right 769 stage shift register is provided with a third input end, coupled to the second clock CLK2 64 of the plural clocks generated by the clock generator 30 and coupled to a starting signal STV 69, the driving method comprises steps of:
generating plural clock signals CLK1-CLK4 by the clock generator 30, for the control of the action of the gate driver unit 28, and adjusting the duty cycle of the first input end CLK4 61 of the Right 768 stage shift register;
transmitting the starting signal STV 69, the first input end CLK4 61, the third input end CLK2 64 and a gate line output GE767 of a front stage shift register to the plural shift registers Right 768, Right 769 corresponding to the last gate line;
connecting the driving signal outputted from the shift register corresponding to the last gate line GE768 to the last row of pixels;
adjusting the trigger edge of CLK3 of the Left 768 shift register corresponding to the last row of pixels according to the foregoing approach, to obtain driving signals GO768;
transmitting the driving signals GO768, GE768 to the last row of the pixel array; and
driving the last row of the pixel array by the driving signals.

According to the driving method of the liquid crystal display device of the present invention, the two gate line outputs GO768, GE768 corresponding to the last row of the pixel array are coupled to the outputs CLK3, CLK4 of the clock generator, where the trigger edge of the CLK3, CLK4 carry out a delay for the rising edge and an advance for the falling edge, to be not in alignment with respect to the rising edge and falling edge of the CLK1, CLK2, so as to achieve the goal of improving the bright line quality of the liquid crystal display device.

To summarize the foregoing description, although the present invention has been disclosed by the aforementioned preferred embodiments, the present invention is not intended to be limited by the embodiments. Any equivalent modifications, made by those with common knowledge in the field of the present invention, without departing from the spirit and scope of the present invention are therefore intended to be embraced. The present invention is intended to be limited only by the scope of the appended claims.

What is claimed is:

1. A liquid crystal display device, comprising:
a liquid crystal panel comprising a pixel array for the display of image;
a gate driver unit having a plurality of gate lines to couple to the pixel array, for the generation of a plurality of first driving signals to drive the pixel array;
a source driver unit for the generation of a plurality of second driving signals to drive the data of image signals; and
a clock generator electrically coupling to said gate driver unit for the generation of a plurality of clock signals to control the action of said gate driver unit;
wherein said gate driver unit further comprises a plurality of shift registers electrically coupled in series, where each shift register corresponds to one row of the pixel array, to control an input clock signal of the shift register where the two gate lines of the shift register couple to the last row of the pixel array, to have a trigger edge of the input clock signal not in alignment with a trigger edge of an input clock signal of a next stage shift register.

2. The liquid crystal display device as claimed in claim 1, wherein a way to control the input clock signal of the shift register having the two gate lines coupling to the last row of the pixel array is through adjustment of duty cycle of the input clock signal.

3. The liquid crystal display device as claimed in claim 2, wherein a way to adjust the duty cycle of the input clock signal is through controlling the rising edge to be delayed and the falling edge to be advanced.

4. The liquid crystal display device as claimed in claim 1, wherein outputs of said clock generator are a plurality of clock signals, and a high voltage level and a low voltage level of the clock signals being a first voltage and a second voltage respectively.

5. The liquid crystal display device as claimed in claim 1, wherein the plurality of shift registers correspond to the last gate line comprises:
a first shift register and a second shift register which is a next stage shift register, where an output of the second shift register couples to the first shift register, and an output of the first shift register is an output of the last gate line, and further coupling to the second shift register, where the first shift register is provided with a first input end which is coupled to one of the plurality of clock signals generated by said clock generator; a second input end coupling to a gate line output of a front stage shift register; and a first output end, where the first output end is a gate line output of the first shift register, and the second shift register being provided with a third input end, coupling to one of the plurality of clock signals generated by said clock generator and coupling to a starting signal.

6. The liquid crystal display device as claimed in claim 1, wherein the adjustment of the duty cycle of one of plurality of clock signals is accomplished by hardware circuits or software in a single chip in said clock generator.

7. A driving method for a liquid crystal display device, where the liquid crystal display device comprises a liquid crystal panel, a gate driver unit, a source driver unit and a clock generator, and the plurality of shift registers corresponding to the last gate line comprising:
a first shift register and a second shift register which is a next stage shift register, where an output of the second shift register couples to the first shift register, and an output of the first shift register is an output of the last gate line, and further coupling to the second shift register, where the first shift register is provided with a first input end which is coupled to one of the plurality of clock signals generated by said clock generator; a second input end coupling to a gate line output of a front stage shift register; and a first output end, where the first output end is a gate line output of the first shift register, and the second shift register being provided with a third input end coupling to one of the plurality of clock signals generated by said clock generator and coupling to a starting signal, the first input end and the third input end being inputted a rising edged and a falling edge clock signals respectively which are aligned in opposite heading to each other, the driving method comprises:
adjusting the duty cycle of one of the plurality of clock signals of the first input end, to have the rising edge and the falling edge of its trigger edges not in alignment with the rising edge and the falling edge of the trigger edges of the input clock of the next stage shift register inputted by the third input end;
transmitting the starting signal, adjusted clock signal of the first input end, one of the plurality of clock signals of the third input end of the next stage shift register and a gate line of front stage shift register to the second input end outputs to the plurality of shift registers corresponding to the last gate line;
transmitting the driving signals to the last row of the pixel array; and
driving the last row of the pixel array by the driving signals.

8. The driving method for a liquid crystal display device as claimed in claim 7, wherein the way to control the input clock signal of the shift register where its two gate lines couple to the last row of the pixel array is through the adjustment of the duty cycle of the input clock pulse.

9. The driving method for a liquid crystal display device as claimed in claim 7, wherein the way to adjust the duty cycle of the input clock pulse is through controlling the rising edge to be delayed and the falling edge to be advanced.

10. The driving method for a liquid crystal display device as claimed in claim 7, wherein said gate driver unit further comprises a plurality of shift registers electrically coupled in series, where each shift register corresponds to one row of the pixel array.

11. The driving method for a liquid crystal display device as claimed in claim 7, wherein outputs of the clock generator are a plurality of clock pulses, and a high voltage level and a low voltage level of the clock signals being a first voltage and a second voltage respectively.
